(19) United States
(12) Patent Application Publication
(10) Pub. No.: US 2017/0167265 A1
(43) Pub. Date: Jun. 15, 2017

(54) STEAM TURBINE, BUCKET, AND METHOD OF MAKING BUCKET

(71) Applicant: GENERAL ELECTRIC COMPANY, Schenectady, NY (US)

(72) Inventor: Theodore W. FANDREI, II, Latham, NY (US)

(21) Appl. No.: 14/965,319

(22) Filed: Dec. 10, 2015

(51) Int. Cl. F01D 5/14; C22C 38/50; C22C 38/44; F01D 5/28; C22C 38/06; C21D 9/00; C21D 8/00; C21D 1/06; C22C 38/54; C22C 38/42

(52) U.S. Cl. CPC F01D 5/147; C22C 38/54; C22C 38/50; C22C 38/44; C22C 38/42; C22C 38/06; C21D 9/0068; C21D 8/005; C21D 1/06; F01D 5/286; C21D 2211/008; F05D 2220/31

(57) ABSTRACT

A bucket includes a bucket body including a precipitation hardened martensitic stainless steel having a tensile strength of at least 1520 MPa (220 KSI) and a notch toughness of at least 41 J (30 ft-lb). The bucket body has a radial length of at least 1.15 meters (45 inches). A steam turbine includes at least one bucket including a precipitation hardened martensitic stainless steel having a tensile strength of at least 1520 MPa (220 KSI) and a notch toughness of at least 41 J (30 ft-lb). The bucket has a radial length of at least 1.15 meters (45 inches). A method of making a bucket having a radial length of at least 1.15 meters (45 inches) includes forming a precipitation hardened martensitic stainless steel having a tensile strength of at least 1520 MPa (220 KSI) and a notch toughness of at least 41 J (30 ft-lb) into the bucket.

### FIELD OF THE INVENTION

The present invention is directed to steam turbines. More specifically, the present invention is directed to a bucket for a steam turbine.

### BACKGROUND OF THE INVENTION

Last stage buckets (LSBs) in steam turbines require high strength and toughness. Titanium is too costly and some precipitation hardened (PH) stainless steels, for example compressor blade material GTD-450, a PH martensitic stainless steel, are not able to reach sufficiently high strength. As used herein, “GTD-450” refers to an alloy including a composition, by weight, of about 15.5% chromium, about 6.3% nickel, about 0.8% molybdenum, about 0.03% carbon, and a balance of iron.

For last stage buckets about 1.15 meters (45 inches) or longer, a much higher strength material is needed. One option is PH 13-8Mo stainless steel, a martensitic precipitation/age-hardened stainless steel that can reach an ultimate tensile strength (UTS) greater than 1520 MPa (220 KSI). UTS is the maximum stress that a material can withstand while being stretched or pulled before failing or breaking.

As used herein, “13-8Mo” refers to an alloy including a composition, by weight, of about 12.25-13.25% chromium, about 7.5-8.5% nickel, about 2.0-2.5% molybdenum, about 0.9-1.35% aluminum, up to about 0.1% silicon, up to about 0.1% manganese, up to about 0.05% carbon, and a balance of iron. PH 13-8Mo stainless steel is capable of high strength and hardness along with good levels of resistance to both general corrosion and stress-corrosion cracking and good ductility and toughness in large sections in both the longitudinal and transverse directions.

Although a high tensile strength material is required in an LSB, the toughness of the material is important for its longevity. Processes that increase the tensile strength of a material typically come with the tradeoff of a decrease in toughness of the material, measured as a notch toughness or impact strength.

In testing, the standard PH 13-8Mo stainless steel material (AMS 5629), which has sufficient tensile strength for a 1.15-m (45-in) bucket, was found to have very poor impact strength. Other commercial materials with sufficient tensile strength but poor impact strength include, but are not limited to, ATI S240® alloy (ATI Properties, Inc., Albany, Oreg.), Custom 455® alloy (CRS Holdings, Inc.), Custom 465® alloy (CRS Holdings, Inc.), and HSL® 185 alloy (Hitachi Metals, Ltd., Tokyo, Japan). Longer length buckets require high toughness to resist the environmental conditions of operation. Amongst the various demands for a design, strength and toughness are two key variables when making longer buckets.

Last stage buckets continue to move to longer radial lengths as the output demands for a turbine increase. Currently, General Electric produces a 1.15-m (45-in) bucket in a titanium alloy, which is very expensive. To make longer LSBs, designers typically had to resort to a lower density alloy like titanium for buckets beyond a certain length. To move to a more cost-effective alloy, a high strength steel would be less costly. Currently General Electric has deployed GTD-450 for some longer last stage buckets, but those buckets are manufactured at the maximum currently attainable UTS. This strength is inadequate for the longer length designs, as the higher density of steel over titanium demands yet higher strength. The alloy 13-8Mo can reach the desired strengths, but the standard commercial material does not have the desired toughness as measured by a notch toughness test.

### BRIEF DESCRIPTION OF THE INVENTION

In an embodiment, a bucket includes a bucket body including a precipitation hardened martensitic stainless steel having a tensile strength of at least 1520 MPa (220 KSI) and a notch toughness of at least 41 J (30 ft-lb). The bucket body has a radial length of at least 1.15 meters (45 inches).

In another embodiment, a steam turbine includes at least one bucket including a precipitation hardened martensitic stainless steel having a tensile strength of at least 1520 MPa (220 KSI) and a notch toughness of at least 41 J (30 ft-lb). The bucket has a radial length of at least 1.15 meters (45 inches).

In another embodiment, a method of making a bucket includes forming a precipitation hardened martensitic stainless steel having a tensile strength of at least 1520 MPa (220 KSI) and a notch toughness of at least 41 J (30 ft-lb) into the bucket. The bucket has a radial length of at least 1.15 meters (45 inches).

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic perspective partial cut away view of a steam turbine in an embodiment of the present invention.

FIG. 2 is a perspective view of a long last stage bucket in an embodiment of the present invention.

Wherever possible, the same reference numbers will be used throughout the drawings to represent the same parts.

### DETAILED DESCRIPTION OF THE INVENTION

Provided are a long last stage bucket (LSB) with a combination of high strength and high toughness, a steam turbine with the long last stage bucket, and a method of making the long last stage bucket.

Embodiments of the present disclosure, for example, in comparison to concepts failing to include one or more of the features disclosed herein, have greater margins of safety with the increased toughness capability in longer last stage buckets (LSBs), lower manufacturing costs over the titanium material currently used, shorter cycle time to obtain the material, better fracture toughness than titanium, or combinations thereof.

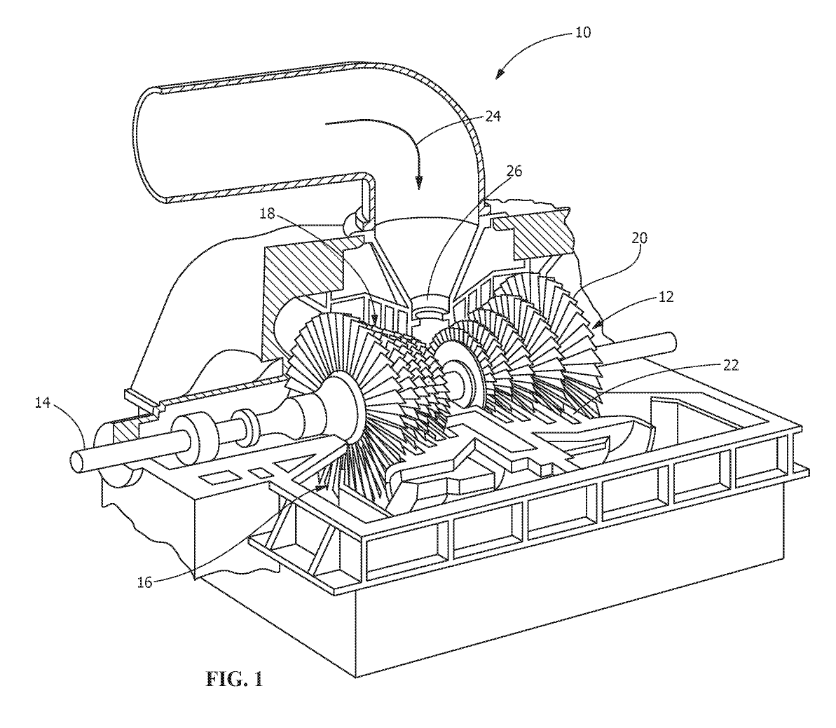

FIG. 1 shows a steam turbine 10 including a rotor 12 with a shaft 14 and a low-pressure (LP) turbine section 16. The LP turbine section 16 includes axially spaced rotor wheels 18. A series of buckets 20 (the last stage of which being labeled as 20 in FIG. 1) are mechanically coupled to each rotor wheel 18. More specifically, the buckets 20 are arranged in rows that extend circumferentially around each rotor wheel 18. A series of stationary nozzles 22 extend circumferentially around the shaft 14 and are axially positioned between adjacent rows of buckets 20. The nozzles 22 cooperate with the buckets 20 to form a turbine stage and to define a portion of a steam flow path through the steam turbine 10.

In operation, steam 24 enters an inlet 26 of the steam turbine 10 and is channeled through the nozzles 22. The nozzles 22 direct the steam 24 downstream against the buckets 20. The steam 24 passes through the remaining stages, imparting a force on the buckets 20, thereby causing the rotor 12 to rotate. At least one end of the steam turbine 10 may extend axially away from the rotor 12 and may be attached to a load or machinery (not shown), which may include, but is not limited to, a generator, another turbine, or a combination thereof

In FIG. 1, the low pressure steam turbine 10 can be seen to have multiple, and more specifically five, stages. The first stage is the smallest in a radial direction of the five stages with the stages increasing in size in the radial direction to the last stage, which is the largest.

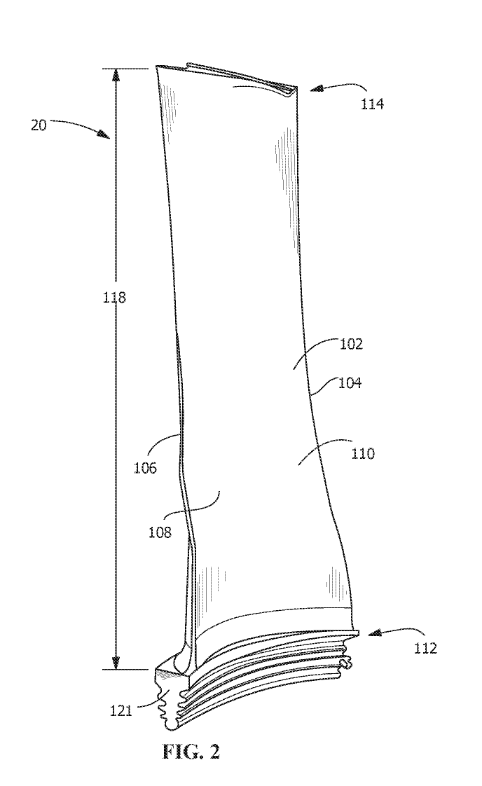

FIG. 2 shows a long last stage turbine bucket 20 from the steam turbine 10. The bucket 20 includes a blade portion 102 with a trailing edge 104 and a leading edge 106. Steam flows generally from the leading edge 106 to the trailing edge 104. The bucket 20 also includes a concave sidewall 108 and a convex sidewall 110. The sidewalls 108, 110 are connected axially at the trailing edge 104 and the leading edge 106 to form the blade 102, which extends a radial length 118 from a rotor blade root 112 to a rotor blade tip 114. The root 112 includes a dovetail 121 used for coupling the bucket 20 to a rotor disk along the shaft 14 of the steam turbine 10.

In one embodiment, a last stage bucket 20, made of PH martensitic stainless steel, has a radial length 118 of at least, and preferably greater than, 1.15 meters (45 inches). The PH martensitic stainless steel has an enhanced toughness while still maintaining sufficient strength. The PH martensitic stainless steel has a tensile strength of at least 1520 MPa (220 KSI) and a notch toughness of at least 41 J (30 ft-lb). The PH martensitic stainless steel preferably also has a fracture toughness of at least 70 MPa·m^{1/2} (63.7 ksi·in^{1/2}). In some embodiments, the PH martensitic stainless steel is a 13-8 alloy (UNS S13800). In some embodiments, the PH martensitic stainless steel is a version of PH 13-8Mo stainless steel commercially available under the trade name Supertough® from ATI Properties, Inc. (Albany, Oreg.) under AMS 5934.

Another PH martensitic stainless steel which may be applicable to the present methods and/or apparatus is MLX17™ alloy (Aubert & Duval, Paris, France). As used herein, “MLX17” refers to an alloy including a composition, by weight, of about 11-12.5% chromium, about 10.25-11.25% nickel, about 1.75-2.25% molybdenum, about 1.35-1.75% aluminum, about 0.2-0.5% titanium, up to about 0.25% silicon, up to about 0.25% manganese, up to about 0.02% carbon, and a balance of iron.

In some embodiments, the PH martensitic stainless steel includes, by weight, about 11.0-15.0% chromium, about 5.0-11.0% nickel, about 1.0%-2.5% molybdenum, about 0.7%-1.5% aluminum, up to about 2.5% copper, up to about 2.0% tungsten, up to about 0.5% titanium, up to about 0.02% carbon, up to about 0.001% boron, incidental impurities, and a balance of iron.

In some embodiments, the PH martensitic stainless steel includes, by weight, about 11.0-12.5% chromium, about 1.0%-2.5% molybdenum, about 0.15-0.5% titanium, about 0.7%-1.5% aluminum, about 0.5%-2.5% copper, about 9.0-11.0% nickel, up to about 0.02% carbon, up to about 2.0% tungsten, up to about 0.001% boron, incidental impurities, and a balance of iron.

In some embodiments, the PH martensitic stainless steel includes a stainless steel alloy having a process history including hot working the stainless steel alloy, quenching the stainless steel alloy, and aging the stainless steel alloy. The stainless steel alloy is not solution heat treated prior to aging. In some embodiments, the hot working includes forging, piercing, rolling, extruding, or combinations thereof. The process history preferably does not include cryogenically cooling the stainless steel alloy.

In some embodiments, the hot working includes a final hot working pass at a hot working temperature greater than a recovery temperature of the stainless steel alloy. In some embodiments, the hot working includes a final hot working pass at a hot working temperature of 815-1150° C. (1500-2100° F.), alternatively 870-1095° C. (1600-2000° F.), alternatively 925-1040° C. (1700-1900° F.), alternatively 925-1010° C. (1700-1850° F.), or any suitable combination, sub-combination, range, or sub-range thereof.

In some embodiments, the hot working includes a reduction of the stainless steel alloy of about 15% to 70%, alternatively of about 18% to about 42%, or any suitable combination, sub-combination, range, or sub-range thereof. The quenching preferably includes water quenching, ice water quenching, or water quenching followed by ice water quenching, and the aging preferably includes heating for an aging time and at an aging temperature sufficient to precipitate at least one hardening phase in the stainless steel.

In some embodiments, the aging temperature is about 510-540° C. (950-1000° F.), alternatively about 510-530° C. (950-985° F.), alternatively about 510-520° C. (950-970° F.), alternatively about 425-650° C. (800-1200° F.), alternatively about 455-595° C. (850-1100° F.), alternatively about 480-565° C. (900-1050° F.), alternatively about 540° C. (1000° F.), or any suitable combination, sub-combination, range, or sub-range thereof, and the aging time is about 4 hours.

The last stage bucket 20 has a radial length 118 of at least 1.15 meters (45 inches), alternatively greater than 1.15 meters (45 inches), alternatively at least 1.27 meters (50 inches), alternatively at least 1.37 meters (54 inches), alternatively at least 1.52 meters (60 inches), alternatively in the range of 1.15-1.52 meters (45-60 inches), alternatively in the range of 1.27-1.37 meters (50-54 inches), alternatively in the range of 1.37-1.52 meters (54-60 inches), or any suitable combination, sub-combination, range, or sub-range thereof.

In some embodiments, processing of the stainless steel alloy relies only on plastic deformation using hot working, without any heavy cold working after the hot working. Hot working, or hot plastic working, may include, but is not limited to, forging, including open and closed die forging, piercing, rolling, and extruding. In some embodiments, only the final pass of the working temperature and reduction, i.e., the last hot working step, is controlled in the hot working. Hot working prior to the final pass may be conducted at a wide range of temperature and reduction combinations.

The percent reduction of the final hot working pass influences the mechanical properties of the thermomechanically treated PH martensitic stainless steel. In an embodiment adapted for long products such as, but not limited to, a long last stage bucket 20, the percent reduction in a final pass may refer to the reduction in cross-sectional area of the bucket 20. In other embodiments, the percent reduction in a final pass may refer to a reduction in thickness.

After hot working, the PH martensitic stainless steel is quenched. The quenching may include, but is not limited to, water quenching, quenching with an aqueous solution, including, but not limited to, a brine solution, oil quenching, quenching in a mixture of water and oil, or combinations thereof. In some embodiments, the initial temperature of the quenching bath is about 18° C. (65° F.), alternatively does not exceed about 38° C. (100° F.), alternatively is in the range of 18-38° C. (65-100° F.), or any suitable combination, sub-combination, range, or sub-range thereof. In some embodiments, the PH martensitic stainless steel is quenched until the temperature of the steel is no greater than about 149° C. (300° F.).

In some embodiments, following quenching, the PH martensitic stainless steel is immersed and held in ice water for a holding time of at least about two hours. In some embodiments, the holding time is in the range of about 2 hours to about 24 hours. Alternatively, any cooling bath may be used within the spirit of the present invention to hold the PH martensitic stainless steel at a temperature below about 10° C. (50° F.), alternatively in the range of 0 to 10° C. (32 to 50° F.), alternatively in the range of 0 to 4° C. (32 to 40° F.), alternatively in the range of −40 to 10° C. (−40 to 50° F.), alternatively in the range of −40 to 4° C. (−40 to 40° F.), alternatively in the range of −34 to 10° C. (−30 to 50° F.), alternatively in the range of −29 to 4° C. (−20 to 40° F.), alternatively in the range of −23 to 4° C. (−10 to 40° F.), alternatively in the range of −18 to 5° C. (0 to 40° F.), or any suitable combination, sub-combination, range, or sub-range thereof. In some embodiments, holding the PH martensitic stainless steel at about the temperature of ice water (0 to 4° C.) stabilizes the residual substructure that forms during the hot plastic deformation of the hot working step. The PH martensitic stainless steel is preferably not exposed to cryogenic temperatures after hot working. In one embodiment, the PH martensitic stainless steel is devoid of exposure to cryogenic temperatures after hot working. As used herein, a cryogenic temperature refers to any temperature lower than about −40° C. (−40° F.).

After quenching or holding the PH martensitic stainless steel at a temperature less than about 10° C. (50° F.), the PH martensitic stainless steel is aged at an elevated temperature. Aging, also referred to as precipitation aging or age hardening, preferably provides a controlled precipitation of strengthening particles in the martensitic steel matrix. Aging preferably results in precipitation of fine strengthening particles distributed throughout the martensitic grains. The aging may include multiple aging steps at different temperatures, used advantageously to improve mechanical properties of the PH martensitic stainless steel.

In some embodiments, the aging time is about 4 hours or less. Other aging times and temperatures may be determined for specific alloys. Aging may include heating the PH martensitic stainless steel with any combination of aging time and aging temperature that is sufficient for the precipitation of one or more hardening phases.

The PH martensitic stainless steel has a tensile strength of at least 1520 MPa (220 KSI), alternatively at least 1550 MPa (225 KSI), alternatively at least 1585 MPa (230 KSI), alternatively at least 1620 MPa (235 KSI), alternatively in the range of 1520-1620 MPa (220-235 KSI), alternatively in the range of 1550-1585 MPa (225-230 KSI), or any suitable combination, sub-combination, range, or sub-range thereof.

The PH martensitic stainless steel has a notch toughness of at least 41 J (30 ft-lb), alternatively at least 47 J (35 ft-lb), alternatively at least 54 J (40 ft-lb), alternatively at least 61 J (45 ft-lb), alternatively at least 68 J (50 ft-lb), alternatively at least 75 J (55 ft-lb), alternatively in the range of 41-75 J (30-55 ft-lb), alternatively in the range of 47-68 J (35-50 ft-lb), alternatively in the range of 54-61 J (40-45 ft-lb), or any suitable combination, sub-combination, range, or sub-range thereof. The notch toughness is measured by a Charpy impact test. The Charpy impact test is a standardized high strain rate test to determine the amount of energy absorbed by the PH martensitic stainless steel during fracture.

The PH martensitic stainless steel preferably has a fracture toughness of at least 70 MPa·m^{1/2} (63.7 ksi·in^{1/2}), alternatively at least 75 MPa·m^{1/2} (68.3 ksi·in^{1/2}), alternatively at least 80 MPa·m^{1/2} (72.8 ksi·in^{1/2}), alternatively at least 85 MPa·m^{1/2} (77.4 ksi·in^{1/2}), alternatively at least 90 MPa·m^{1/2} (81.9 ksi·in^{1/2}), alternatively at least 95 MPa·m^{1/2} (86.5 ksi·in^{1/2}), alternatively in the range of 70-95 MPa·m^{1/2} (63.7-86.5 ksi·in^{1/2}), alternatively in the range of 75-90 MPa·m^{1/2} (68.3-81.9 ksi·in^{1/2}), alternatively in the range of 80-85 MPa·m^{1/2} (72.8-77.4 ksi·in^{1/2}), or any suitable combination, sub-combination, range, or sub-range thereof. The fracture toughness is the measured linear elastic fracture toughness (K_{IC} value) for the PH martensitic stainless steel based on the initiation of unstable crack growth as measured by a standardized linear-elastic plane-strain fracture toughness test.

The long last stage bucket 20 having a radial length 118 of at least 1.15 meters (45 inches) may be formed by any method that maintains or achieves the desired physical properties imparted to the PH martensitic stainless steel, such as those imparted by the above-described process history. The long last stage bucket 20 may be shaped into a final form before, during, or after the process history to maintain or achieve the desired physical properties. In some embodiments, the long last stage bucket 20 is formed by a forging process. In some embodiments, the long last stage bucket 20 is machined from a rolled and heat-treated bar.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A bucket comprising:
a bucket body comprising a precipitation hardened martensitic stainless steel having a tensile strength of at least 1520 MPa (220 KSI) and a notch toughness of at least 41 J (30 ft-lb), the bucket body having a radial length of at least 1.15 meters (45 inches).

2. The bucket of claim 1 wherein the precipitation hardened martensitic stainless steel has a fracture toughness of at least 70 MPa·m^{1/2} (63.7 ksi·in^{1/2}).

3. The bucket of claim 1 wherein the bucket is a long last stage bucket of a steam turbine.

4. The bucket of claim 1 wherein the precipitation hardened martensitic stainless steel comprises in percent by weight:
11.0% to 12.5% chromium;
1.0% to 2.5% molybdenum;
0.15% to 0.5% titanium;
0.7% to 1.5% aluminum;
0.5% to 2.5% copper;
9.0% to 11.0% nickel;
up to 0.02% carbon;
up to 2.0% tungsten;
up to 0.001% boron;
iron; and
incidental impurities.

5. The bucket of claim 1 wherein the precipitation hardened martensitic stainless steel comprises a stainless steel alloy having a process history comprising:
hot working the stainless steel alloy;
quenching the stainless steel alloy; and
aging the stainless steel alloy, wherein the stainless steel alloy is not solution heat treated prior to aging the stainless steel alloy.

6. The bucket of claim 5 wherein the hot working comprises at least one of forging, piercing, rolling, and extruding.

7. The bucket of claim 5 wherein the hot working comprises a final hot working pass at a hot working temperature greater than a recovery temperature of the stainless steel alloy.

8. The bucket of claim 5 wherein the hot working comprises a final hot working pass at a hot working temperature of 815° C. (1520° F.) to 1150° C. (2100° F.).

9. The bucket of claim 5 wherein the hot working comprises a reduction of the stainless steel alloy of 15% to 70%, the quenching comprises water quenching, ice water quenching, or water quenching followed by ice water quenching, and the aging comprises heating for an aging time and at an aging temperature sufficient to precipitate at least one hardening phase in the stainless steel.

10. The bucket of claim 9 wherein the aging temperature is about 510° C. (950° F.) to about 540° C. (1000° F.) and the aging time is about 4 hours.

11. The bucket of claim 5 wherein the process history does not include cryogenically cooling the stainless steel alloy.

12. A steam turbine comprising:
at least one bucket comprising a precipitation hardened martensitic stainless steel having a tensile strength of at least 1520 MPa (220 KSI) and a notch toughness of at least 41 J (30 ft-lb), the bucket having a radial length of at least 1.15 meters (45 inches).

13. The steam turbine of claim 12 wherein the precipitation hardened martensitic stainless steel has a fracture toughness of at least 70 MPa·m^{1/2} (63.7 ksi·in^{1/2}).

14. The steam turbine of claim 12 wherein the bucket is a long last stage bucket.

15. The steam turbine of claim 12 wherein the precipitation hardened martensitic stainless steel comprises in percent by weight:
11.0% to 12.5% chromium;
1.0% to 2.5% molybdenum;
0.15% to 0.5% titanium;
0.7% to 1.5% aluminum;
0.5% to 2.5% copper;
9.0% to 11.0% nickel;
up to 0.02% carbon;
up to 2.0% tungsten;
up to 0.001% boron;
iron; and
incidental impurities.

16. The steam turbine of claim 12 wherein the precipitation hardened martensitic stainless steel comprises a stainless steel alloy having a process history comprising:
hot working the stainless steel alloy;
quenching the stainless steel alloy; and
aging the stainless steel alloy, wherein the stainless steel alloy is not solution heat treated prior to aging the stainless steel alloy.

17. A method of making a bucket comprising:
forming a precipitation hardened martensitic stainless steel having a tensile strength of at least 1520 MPa (220 KSI) and a notch toughness of at least 41 J (30 ft-lb), into the bucket, the bucket having a radial length of at least 1.15 meters (45 inches).

18. The method of claim 17 wherein the precipitation hardened martensitic stainless steel comprises in percent by weight:
11. 0% to 12.5% chromium;
1.0% to 2.5% molybdenum;
0.15% to 0.5% titanium;
0.7% to 1.5% aluminum;
0.5% to 2.5% copper;
9.0% to 11.0% nickel;
up to 0.02% carbon;
up to 2.0% tungsten;
up to 0.001% boron;
iron; and
incidental impurities.

19. The method of claim 17 wherein the precipitation hardened martensitic stainless steel has a fracture toughness of at least 70 MPa·m^{1/2} (63.7 ksi·in^{1/2}).

20. The method of claim 17, wherein the precipitation hardened martensitic stainless steel comprises a stainless steel alloy, the method further comprising:
hot working the stainless steel alloy;
quenching the stainless steel alloy; and
aging the stainless steel alloy, wherein the stainless steel alloy is not solution heat treated prior to aging the stainless steel alloy.
